(19) United States
(12) Patent Application Publication
(10) Pub. No.: US 2010/0302668 A1
(43) Pub. Date: Dec. 2, 2010

(54) Parallel Information Processing on a Hard Disk Drive

(76) Inventor: Vladimir L. Safonov, (US)

Correspondence Address: Vladimir L. Safonov, 1682 Crescent Knolls Glen, Escondido, CA, 92029, US

(21) Appl. No.: 12/790,580

(22) Filed: May 28, 2010

Related U.S. Application Data
(60) Provisional application No. 61/217,373, filed on May 29, 2009.

(51) Int. Cl. G11B 20/10

(52) U.S. Cl. 360/39; G9B/20.009

(57) ABSTRACT

A method of how to perform parallel binary information processing on a hard disk drive with magnetic media is invented. Two or more recording heads synchronously and independently write the binary information in the form of “positive” or “negative” “pulses”. All previous information is erased. Then, the sensors synchronously read the profiles of previously written information. As the result of adding, we obtain the superimposed signals that contain information on logic operations. Such operations can be made in parallel for several independent channels of information and with different groups of binary numbers.

### CROSS-REFERENCE TO RELATED APPLICATIONS

This patent application claims the benefit of the U.S. Provisional Patent Application No. 61/217,373 filed May 29, 2009, which is hereby incorporated by reference in their entirety.

### FIELD OF THE INVENTION

The present invention relates to the parallel information processing operations of magnetic recording devices, and more particularly to the method of how to perform the parallel information processing (logic operations, a comparison of binary numbers, etc.) on a hard disk drive with two or more write-and-read heads.

### BACKGROUND OF THE INVENTION

The hard disk drive is usually used as a binary information storage device, which consists of one or several rapidly rotating platters with magnetic surfaces and write-and-read heads. The voltage applied to the writing head creates a magnetic field that orients the magnetic particles on the surface of the disk. Switching the direction of the magnetic field yields a transition between the uniformly magnetized regions on the magnetic surface. This transition is usually detected as a binary 1 by a reading sensor. The absence of the transition at the measurement time is set to 0.

Our invention gives a practical new feature for the hard disk drive. It can work as a parallel information processor, which is capable of processing simultaneously two or more binary numbers and of doing logic operations. These binary information operations on the hard disk drive can be used as both a supplemental tool for a conventional semiconductor processor and for independent data processing. The speed of this processor can be very high (˜10⁹ bit/sec): it is defined by the number of revolutions per second (˜10² sec⁻¹) multiplied by the bit length of the track (˜10⁻¹ bit). The advantages include long binary word processing and relatively small energy consumption which is mostly defined by the motor.

The method of performing information processing operations on a hard disk drive includes three important conditions. The first condition is that we should be able to record independently and synchronously the binary information from the different channels to the corresponding number of tracks (two or more). With the current technology we can do it using different recording heads and the cylinder tracks. In general, a set of write-and-read heads can be designed to be located close to the magnetic surface of a disk to write and read binary information from the corresponding set of tracks.

The second condition is that we should be able to read synchronously the previously written binary information and superimpose the signals from the different reading magnetoresistive sensors. In other words, we should obtain the resulting magnetization profile from two or more tracks that contains joint information about the stored numbers. In the case of two numbers we obtain the results of logic operations.

The third condition is: in order to perform logic operations the binary information must be represented as a sequence of “positive” (+I) or “negative” (−I) magnetic “pulses” (see below). In terms of conventional transitions the signal is encoded as 0→(00)=O and 1→(11)=I.

The logic operation includes two disk revolutions. First revolution: two writing heads record synchronously and independently on two tracks the first (A) and the second (B) binary numbers as the sequence of “positive” or “negative” “pulses”. All previous information is erased. Second revolution: the added signals from the two reading sensors give the magnetization profile of previously written information and the result of the logic operation for A and B. Analogously a comparison (logics) can be made of three or more binary numbers.

### SUMMARY OF THE INVENTION

The main objective of the present invention is to provide a method of performing parallel information processing on a hard disk drive.

Another objective of the present invention is to integrate the storage and information processing into a single device, which can be used as both a supplemental tool for a conventional computer and for independent data processing.

### BRIEF DESCRIPTION OF THE DRAWINGS

A complete understanding of the present invention may be obtained by referring to the accompanying drawings, when considered in conjunction with the subsequent, detailed description, in which:

FIG. 1 is a schematic diagram of the logic operations (with two numbers, n=2) and information processing (with three or more numbers, n>3). For parallel processing we have to use two or more similar schemes.

FIG. 2 is an illustration of the magnetization profile along the track (x) for the numbers with a) “positive” pulses (B=IOIO) and b) “negative” pulses (−B=−IO−IO). The vertical dotted lines separate different bits. The ones denote magnetization transitions (up and down), and the zeros indicate the absence of transitions. The arrows denote the magnetization orientation.

FIG. 3. a) Magnetization profile along the first track which corresponds to the number A=IOIO with two positive pulses. b) Magnetization profile along the second track with the number B=IOOI. c) The resulting magnetization profile (which can be obtained from two sensors) consists of one big and two small pulses. Signals that contain any magnetization transition give the OR logic operation: IOII=(IOIO)OR(IOOI)=(A)OR(B). Signals that correspond to the big transitions give the AND logic operation 1000=(IOIO)AND(IOOI)=(A)AND(B). Signals that correspond to the small transitions give the XOR logic operation OOII=(IOIO)XOR(IOOI)=(A)XOR(B).

FIG. 4. a) Magnetization profile A=IOIO along the first track. b) Magnetization profile −B=−IOOI−I along the second track. c) The resulting magnetization profile measured by two sensors is C=OOI−I. Neglecting the signs of the pulses, we obtain C=OOII=(IOIO)XOR(IOOI)=(A)XOR(B).

FIG. 5. a) Magnetization profile A=IOIO along the first track. b) Magnetization profile B=−I−I−I−I along the second track. c) The resulting magnetization profile measured by two sensors is C=O−IO−O. Neglecting the signs of the pulse in C, we have C=NOT(A)=OIOI.

### DESCRIPTION OF THE PREFERRED EMBODIMENT

Without loss of generality we shall describe how the method works for a perpendicular magnetic recording medium. Quite analogous procedure is applied for the longitudinal, tapes, patterned media, etc. A “pulse” representation of binary numbers would be a natural coding for the patterned media.

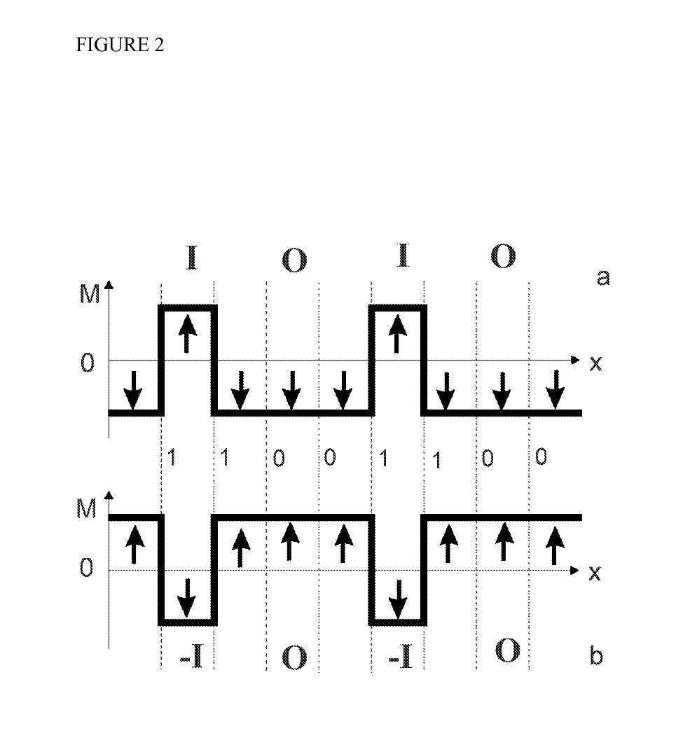

We consider the situation when the disk with magnetic surfaces rotates and the currents create the magnetic fields in the write heads to record the binary numbers. Let the absolute value of recording medium magnetization is equal to M. Applying the fields up and down, we erase all the previous binary information and obtain a new written pattern (a number on a track) with -M and +M states and transitions between these states (see, FIG. 2a).

The binary information should be represented in the form of “positive” or “negative” “pulses” of magnetization M (e.g., FIG. 2a and FIG. 2b, respectively). The positive pulse corresponds to the following encoding: 1 →11=I. The absence of pulse is 0 →00=O.

Then, after a revolution, we read synchronously the signals of two (or more) sensors and obtain the result of binary numbers superimposition. For two numbers this superimposition gives logic operations. For more numbers we have information useful for number comparison and correlations.

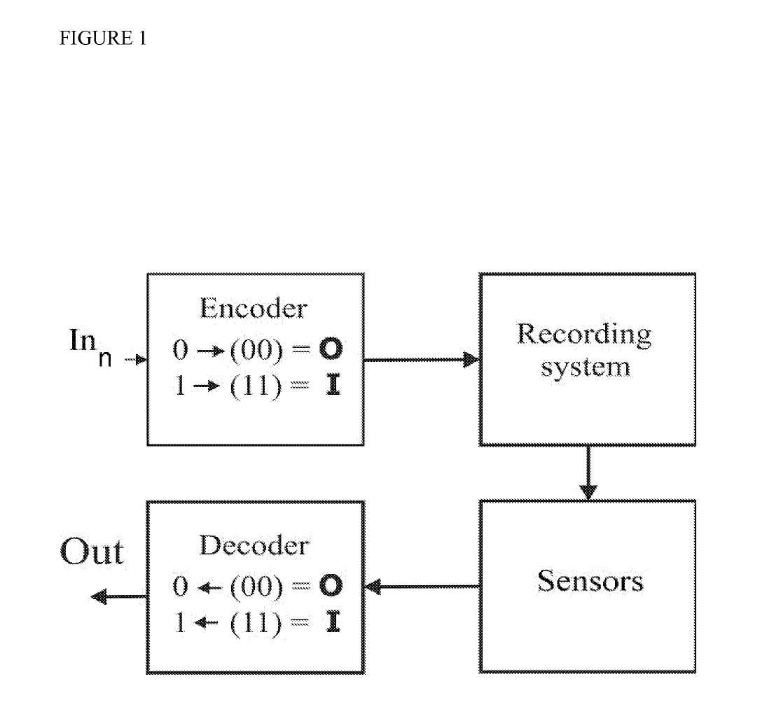

FIG. 1 illustrates a block-scheme of the logic device.

The input sequentially gives binary numbers and the instruction to perform either logic operations (for two numbers) OR, AND, XOR or NOT, or number correlations (for three and more numbers).

The encoder transforms the binary numbers into a doubled form 0→00=O, 1→11=I (pulse), for example, 1010→11)(00)(11)(00)=IOIO=A and 1001→(11)(00)(00)(11)=IOOI=B.

The recording system includes the recording heads, the magnetic medium and the reading sensors. Modulation creates the currents corresponding to binary numbers. The writing heads record these information to corresponding tracks on the magnetic recording medium. The reading sensors synchronously detect the magnetization transitions (associated with pulses). Thus we obtain the correlation information. In a simple case the sensors detect just the fact of magnetization transition and therefore its sign (up or down) does not matter.

A decoder transforms I=11 to 1 and O=00 to 0 and sends it to the output.

For parallel processing we have to use two or more similar encoding-decoding schemes independently.

FIG. 2 illustrates a) the number with the “positive” pulses IOIO and b) the number with the “negative” pulses −IO−I O. The latter is the result of inversion of the first number relative to the horizontal axis M=0. It is easy to check that superimposition of IOIO and −IO−I O gives OOOO.

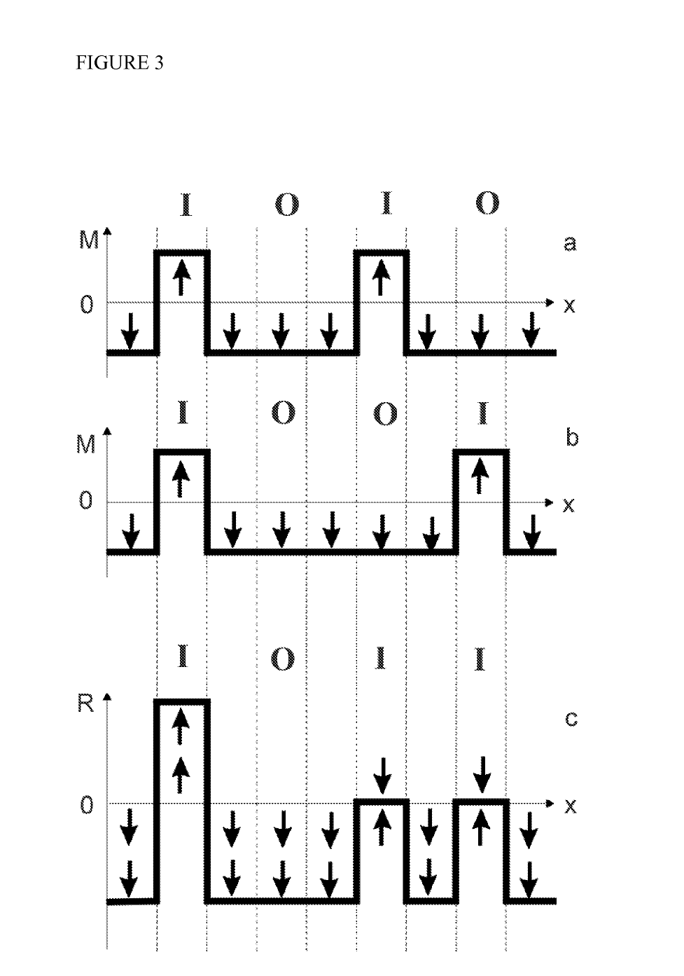

FIG. 3 illustrates the OR operation with the sensors that does not distinguish the height of peaks: (IOIO)OR(IOOI)=IOII. For the sensors that detect only big magnetization transitions we have AND logical operation: (IOIO)AND(IOOI)=IOOO.

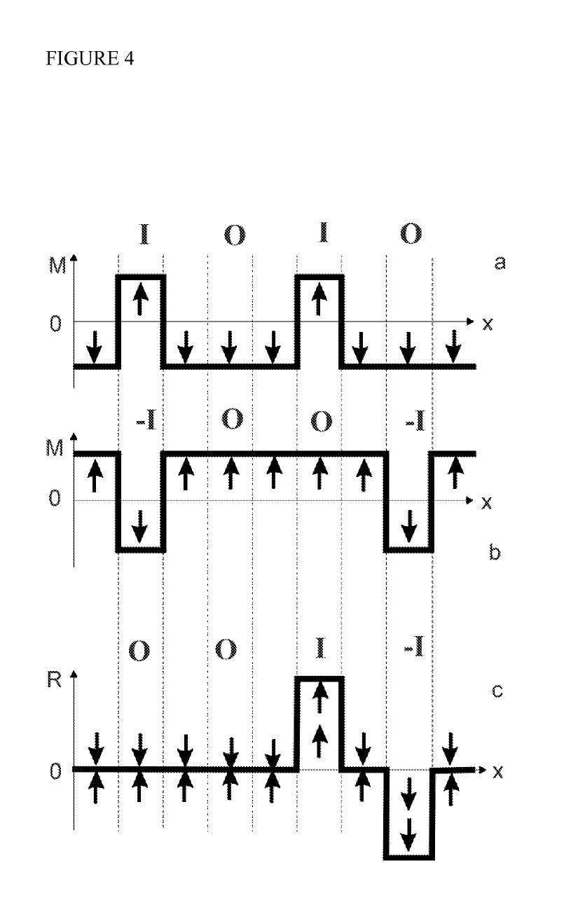

FIG. 4 illustrates the XOR operation. Superimposing the signals of first number A=IOIO and the second number B (in the form of −B=−IOO−I we obtain C=001−I. Neglecting the pulse sign (in a simplest case the sensor does not detect this sign), one has C=OOII and C=(A)XOR(B)=(IOIO)XOR(IOOI). Thus, the superimposition of A and −B gives C=(A)XOR(B) for any numbers A and B.

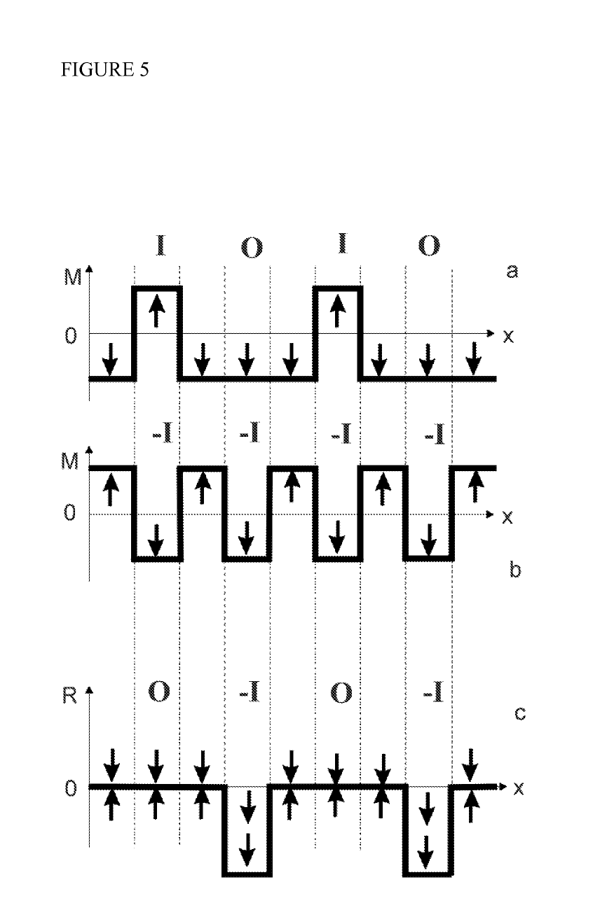

The superimposition of any number A with “positive” pulses and the sequence of “negative” pulses gives the NOT operation. FIG. 5 illustrates this NOT operation. The number IOIO is superimposed with the sequence of negative pulses −I−I−I−I. The result is O−IO−I. Neglecting the sign of the resulting pulses, we have: NOT(IOIO)=0101.

For the purpose of search we can write the first number A once and then compare this number with a set of numbers B₁, B₂, . . . , writing these numbers and reading together with A.

The time necessary for logic operations is very small and therefore the magnetic medium can consist of particles with small anisotropy fields. This will reduce energy and heat losses. The particles can also be smaller in size than the standard recording particles, which is important for noise reduction. In order to solve the problem of bit synchronization at superimposition one can increase the linear size of the pulse for example, by introducing extra zeros for coding (11 become 101, and so on). All (or a part of) logic instructions can be written on the same hard drive. In addition, logic operations can also be performed on a magnetic tape or any other mechanically moving recording media with independent tracks. The results of XOR and AND logic operations can be used to construct an adder in a conventional way.

It is possible to design the system of write-and-read heads that would record and read the information from given tracks on one surface of the disk. In this case we obtain the multi-channel and parallel information processing system.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of performing a logic operation by superimposing n binary numbers, where n is equal or greater than two, on a hard disk drive, said hard drive comprising a recording medium comprising n recording tracks, and n read/write heads configured in their writing mode to apply independent and synchronous magnetic fields to said n different recording tracks and also being configured in their reading mode to read independently and synchronously magnetic fields from said n different recording tracks, and furthermore, said n different recording tracks configured to respond to said magnetic fields applied independently and synchronously by said n read/write heads, said method comprising:
a. encoding said binary numbers into a m-bit binary code, where m is equal or greater than two;
b. recording independently and synchronously each bit of the m-bit code of said n binary numbers on distinct locations on said n different recording tracks by means of said n read/write heads in their said writing mode;
c. reading independently and synchronously each bit of the m-bit code of said n binary numbers on distinct locations from said n different recording tracks by means of said n read/write heads operating in their said reading mode;
d. performing result of said a logic operation by superimposing independent and synchronous readings of n binary numbers;
e. decoding said result from said m-bit binary code into a binary number.

2. The method of performing a logic operation of claim 1 wherein m is equal to two and also wherein said encoding of said binary number is such that if one of said binary numbers is “0” then it is converted to “00” and if one of said binary numbers is “1” then it is converted to “11” and furthermore wherein said decoding of said binary number is such that if said result is “00” then it is converted to “0” and if said result is “11” then it is converted to “1”.

3. The method of performing a logic operation of claim 1 wherein n is equal to two and wherein said operation is an AND function.

4. The method of performing a logic operation of claim 1 wherein n is equal to two and wherein said operation is an OR function.

5. The method of performing a logic operation of claim 1 wherein n is equal to two and wherein said operation is an XOR function.

6. The method of performing a logic operation of claim 1 wherein n is equal to two and wherein said operation is a NOT function.

7. A method of performing parallel information processing in several independent said channels wherein each said channel represents the method of claim 1.
